(19) United States
(12) Patent Application Publication
(10) Pub. No.: US 2020/0015472 A1
(43) Pub. Date: Jan. 16, 2020

(54) APOSEMATIC MIMICRY DEVICE

(71) Applicant: Carol L. dePaiva, Tiverton, RI (US)

(72) Inventor: Carol L. dePaiva, Tiverton, RI (US)

(21) Appl. No.: 16/511,529

(22) Filed: Jul. 15, 2019

Related U.S. Application Data
(60) Provisional application No. 62/698,183, filed on Jul. 15, 2018.

(51) Int. Cl. A01M 29/08; A01K 27/00

(52) U.S. Cl. CPC A01M 29/08; A01K 27/006; A01K 27/002

(57) ABSTRACT

A protective aposematic mimicry device is provided. The device mimics natural aposematic signals found in nature to deter a predator from attacking a small animal or pet. The device includes a harness, a winged shape cutout for attaching to the harness and model eyes attached to the winged shaped cutout. In an alternate embodiment the harness includes model eyes functioning as buttons for attaching the winged shaped cutout to the harness.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/698,183, entitled “APOSEMATIC MIMICRY DEVICE”, naming Carol L. Paiva as inventor, filed 15 Jul. 2018.

### BACKGROUND

### 1. Field of Use

The present invention relates generally to the protection of animals such as dogs and other domesticated animals from predator attacks. More particularly the invention relates to a wearable aposematic vest configured to deter predators in general from attacking a dog wearing the aposematic vest; and more particularly for deterring birds of prey from attacking a dog wearing the aposematic vest.

### 2. Description of Prior Art (Background)

Raptors are birds of prey. They are carnivorous birds with strong bills, large talons and exceptional flight capabilities that hunt small animals. There are more than five hundred species of raptors worldwide. Different species of raptors can be found in every type of habitat.

Raptors are characterized by a hooked beak, razor-sharp talons on strong feet and excellent eyesight. They hunt with their large strong talons and sharply hooked bills. Most raptors capture exclusively live prey. Large raptors will routinely attack animals that weigh up to twenty pounds as part of a hunt, and many birds of prey will attack even larger animals if the bird feels its nest or young is threatened. Even though animals heavier than twenty pounds cannot physically be picked, usually, up by most birds of prey small pets are often harmed or killed by birds attempting to take them.

Different types of raptors have varying ways to kill their pretty. A hawk kills its prey with its claws as wile a falcon uses its claws to catch its prey but kills the small animal with its mouth instead of its claws. But all capture their prey with the talons on their powerful feet.

The raptor's talons are often the primary weapons of death, and protection, for raptors. A raptor's large and powerful feet can exert enough pressure to puncture thick skin, often crushing and killing prey instantly. Once a raptor seizes its prey, the bird generally will not release it until the prey stops moving. A golden eagle that weighs about nine pounds with a seven-foot wingspan can grip with its claws with an estimated strength of several hundred pounds per square inch.

In addition to their strong talons, birds of prey have extremely fast and precise dives that make it difficult, if not impossible, for an animal to avoid attack. Raptors are precision aerial divers, dropping at astonishing rates from seemingly nowhere to seize their prey. For example, eagles dive as fast as one hundred and fifty to two hundred miles per hour, falcons dive at over a hundred miles per hour and hawks dive at speeds up to one hundred and eighty miles an hour.

Raptors are relatively quiet when hunting. Raptors may be active at any time of day or night, though owls are the most common nocturnal birds of prey while others are diurnal and will be most active when their preferred prey is active, making hunting easier

Birds of prey have very keen eyesight. They locate and distinguish prey from a great distance. As to their prey, raptors cannot distinguish between a wild creature and a domestic pet.

Therefore, a deterrent device is needed to help protect small pets from raptor attacks. Preferably, the device is passive, i.e., does not require batteries or charging; and, mimics nature to deter the raptor attack.

### BRIEF SUMMARY

The present invention is an anti-predator aposematic mimicking device designed to signal the unprofitability of a potential prey to its predators. The unprofitability visual signal consist of a pair of winged shaped devices, or cutouts, comprising eyes and a material that is reflective, iridescent and/or may be a holographic material applied to a fabric or other type of substrate, aposematically mimicking that the wearer of the device may be difficult to eat, such as toxicity, foul tasting or more aggressive than the raptor (e.g., that the raptor could become the prey).

In one embodiment an aposematic mimicry device (AMD) for passively deterring predators away from a pet. The AMD includes a harness having a plurality of straps for attaching the AMD to the pet and a harness first attachment area for attaching a wing shaped cutout. The AMD also includes the winged shaped cutout having top and bottom surfaces, wherein the wing shaped cutout top surface includes a plurality of model eyes. The bottom surface of the wing shaped cutout includes a second attachment area for attaching the wing shaped cutout to the harness first attachment area.

The invention is also directed towards an aposematic mimicry device (AMD) for passively deterring predators away from a pet. The AMD includes a harness having a plurality of straps for attaching the AMD to the pet; a plurality of model eyes, wherein each of the plurality of eyes functions as a model eye and a button for attaching a wing shaped cutout. The AMD includes the winged shaped cutout having top and bottom surfaces, wherein the wing shaped cutout comprises a plurality of button holes for receiving the plurality of model eyes and attaching the wing shaped cutout to the harness.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is perspective view of a dog wearing an aposematic device in accordance with features of the present invention;

FIG. 2 is a top view, seen from the predator's view point, of the aposematic device in accordance with the invention shown in FIG. 1;

FIG. 3A is a bottom view of a buckling harness for attaching the aposematic device shown in FIG. 1 to the dog;

FIG. 3B is a bottom view of a hook and loop attaching harness for attaching the aposematic device shown in FIG. 1 to the dog;

FIG. 4 is a top view of the hook and loop attaching harness shown in FIG. 3B;

FIG. 5 is a bottom view of the aposematic device shown in FIG. 1;

FIG. 6 is a top view of buckling harness shown in FIG. 3A with buttons functioning as buttons and model eyes;

FIG. 7 is FIG. 6 is a top view of buckling harness shown in FIG. 4 with buttons functioning as buttons and model eyes;

FIG. 8 is a bottom view of the aposematic device shown in FIG. 5 with button holes.

### DETAILED DESCRIPTION

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

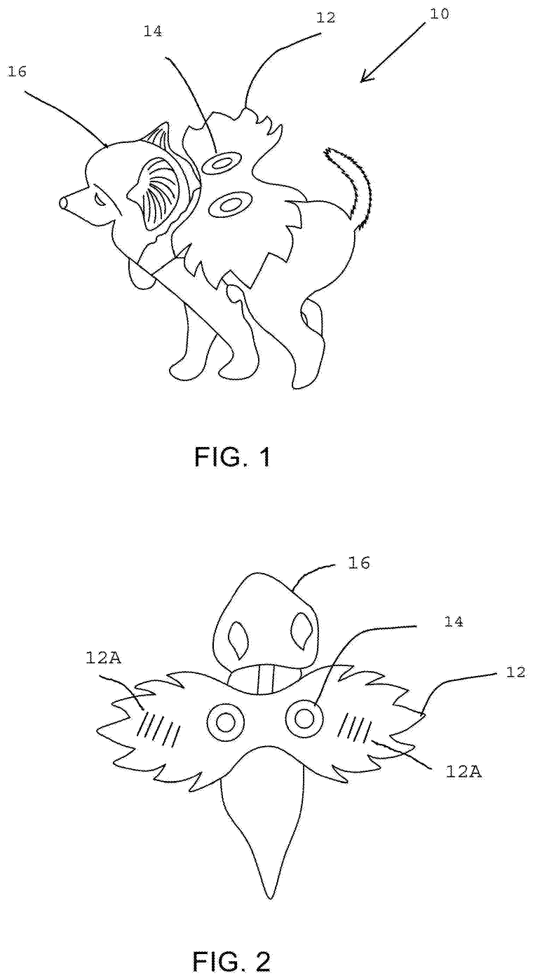

Referring now to FIG. 1 of the drawings there is shown a perspective view of a dog wearing an aposematic device 10 in accordance with features of the present invention. The aposematic device includes wing shape 12 and model eyes 14. The wing shape 12 may be constructed with any suitable material such as for example, material that is reflective, iridescent and/or holographic material applied to a fabric or other type of substrate; and, along with the eyes 14, aposematically mimicking that the wearer of the device may be difficult to eat or a predator. Model eyes may be any suitable shape, size, or color suitable for mimicking aposematic signals. It will be appreciated that model eyes 14 may also be buttons attached to the buckling harness 39 (described herein), for attaching the aposematic device 12 to the buckling harness 39.

Referring also to FIG. 2 there is shown a top view, seen from the predator's view point, of the aposematic device in accordance with the invention shown in FIG. 1. It will be appreciated that the wearer 16 of the aposematic device contributes to the mimicry to deter airborne predators. It will be appreciated that wing shape 12 may be any suitable material such as reflective, and/or holographic and/or iridescent material, indicated as 12A in FIG. 2. It will be also appreciated that any part of wing shape 12 may be reflective and/or holographic and/or iridescent material.

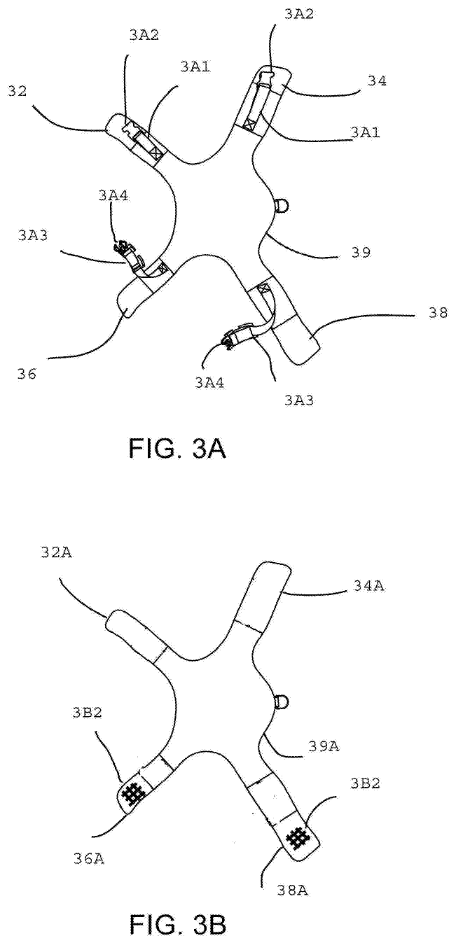

Referring also to FIG. 3A there is a bottom view of a buckling harness 39 for attaching the aposematic device 10 shown in FIG. 1 to the dog 16. Buckling harness 39 includes bayonet type buckle pairs 3A2/3A4 connected to arms, or straps, 32, 34, 36, and 38, and are adjustable to fit different size pets. In practice the arms are wrapped around the dog's torso region and buckled to together. For example, arms 32 and 36 are connectable around the dog's torso region, while arms 34 and 38 are connectable around a second region of the dog's torso region.

Referring also to FIG. 3B is a bottom view of a hook and loop attaching harness 39A for attaching the aposematic device 10 shown in FIG. 1 to the dog 16. Buckling harness 39A includes arms 36A and 38A having VELCO strips or pads 3B2 attached to the ends of the arms. As will be described herein, the hook and loop strips match with hook and loop strips attached to the top side of arms 32A and 34A.

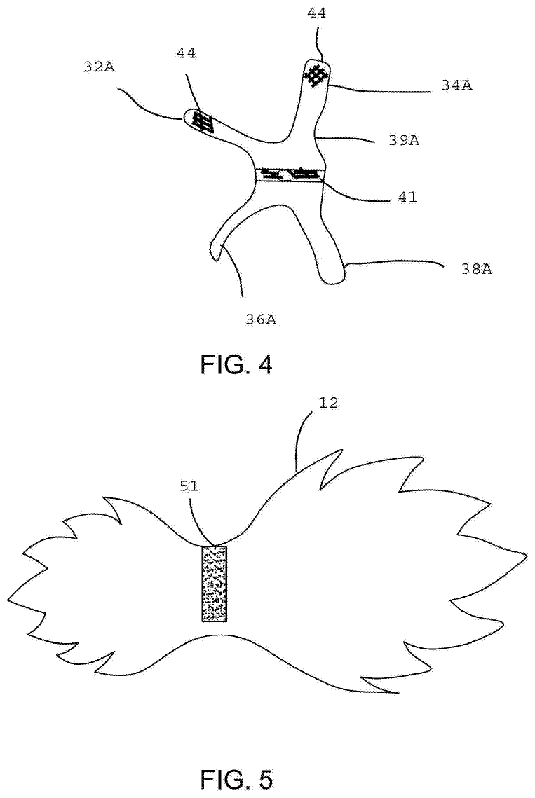

Referring also to FIG. 4 there is shown a top view of the hook and loop attaching harness 39A shown in FIG. 3B. As discussed previously VECRO strips 44 on arms 32A and 34A match with hook and loop strips 32B on the underside of arms 36A and 38A when the harness is fastened to dog 16.

Still referring to FIG. 4 there is shown an attachment area 41 for attaching the aposematic device to harness 39 or 39A. The attachment area may consist of any suitable means for attaching such as, for example, hook and loop.

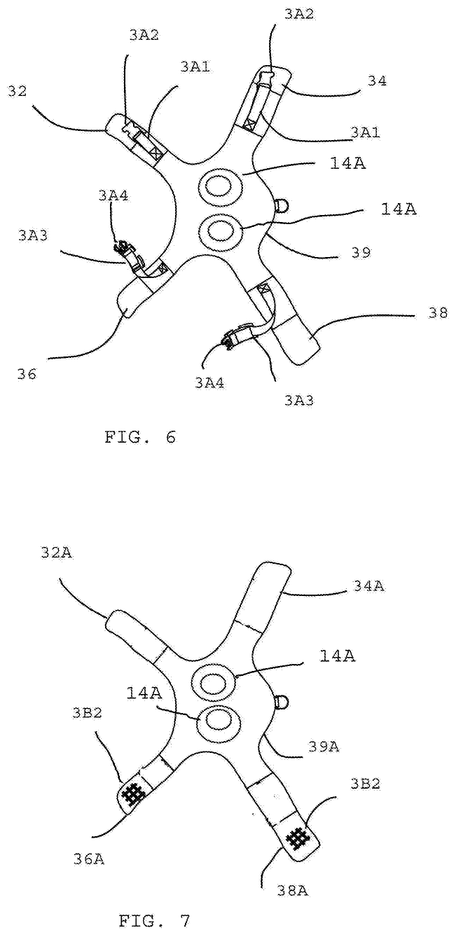

Referring also to FIG. 5 there is shown a bottom view of the aposematic device 12 shown in FIG. 1. Included is attachment area 51 for attaching to attachment area 41 on harness 39 or 39A. The attachment area 51 may include any suitable means for attaching such as hook and loop.

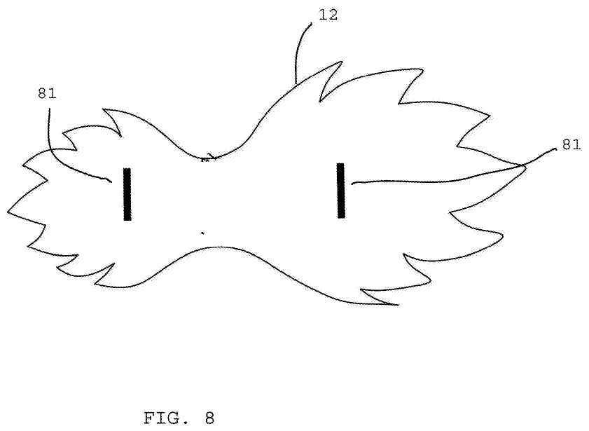

Referring also to FIG. 6 and FIG. 7 there is shown the harness with model eyes 14 attached to harness 39 and 39A, respectively. It will be appreciated that model eyes 14A function as model eyes and buttons.

Referring also to FIG. 8 there is shown a plurality of button holes 81 for receiving model eyes 14A.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

What is claimed is:

1. An aposematic mimicry device (AMD) for passively deterring predators away from a pet, the aposematic device comprising:
a harness; and
a winged shaped cutout having top and bottom surfaces, wherein the bottom surface is connectable to the harness.

2. The AMD as in claim 1, wherein the harness comprises
a plurality of straps for attaching the AMD to the pet; and
a first harness attachment area for attaching the wing shaped cutout.

3. The AMD as in claim 2, wherein the plurality of straps comprises bayonet type buckle pairs.

4. The AMD as in claim 2, wherein the plurality of straps comprises hook and loop fasteners

5. The AMD as in claim 1 wherein the wing shaped cutout top surface comprises a plurality of model eyes.

6. The AMD as in claim 6 wherein the wing shaped cutout comprises a reflective material.

7. The AMD as in claim 6 wherein the wing shaped cutout comprises an iridescent material.

8. The AMD as in claim 6 wherein the wing shaped cutout comprises a holographic material.

9. The AMD as in claim 1 wherein the bottom surface of the wing shaped cutout comprises a second attachment area for attaching the wing shaped cutout to the harness first attachment area.

10. An aposematic mimicry device (AMD) for passively deterring predators away from a pet, the AMD comprising:
a harness, wherein the harness comprises:
a plurality of straps for attaching the AMD to the pet;
a harness first attachment area for attaching a wing shaped cutout; and
the winged shaped cutout having top and bottom surfaces, wherein the wing shaped cutout top surface comprises a plurality of model eyes, wherein the bottom surface of the wing shaped cutout comprises a second attachment area for attaching the wing shaped cutout to the harness first attachment area.

11. The AMD as in claim 10, wherein the plurality of straps comprises bayonet type buckle pairs.

12. The AMD as in claim 10, wherein the plurality of straps comprises hook and loop fasteners

13. The AMD as in claim 10 wherein the wing shaped cutout comprises a reflective material.

14. The AMD as in claim 10 wherein the wing shaped cutout comprises an iridescent material.

15. The AMD as in claim 10 wherein the wing shaped cutout comprises a holographic material.

16. An aposematic mimicry device (AMD) for passively deterring predators away from a pet, the AMD comprising:
a harness, wherein the harness comprises:
a plurality of straps for attaching the AMD to the pet;
a plurality of model eyes, wherein each of the plurality of eyes functions as
a model eye and a button for attaching a wing shaped cutout; and
the winged shaped cutout having top and bottom surfaces, wherein the wing shaped cutout comprises a plurality of button holes for receiving the plurality of model eyes.

17. The AMD as in claim 16, wherein the plurality of straps comprises bayonet type buckle pairs.

18. The AMD as in claim 16, wherein the plurality of straps comprises hook and loop fasteners.

19. The AMD as in claim 16 wherein the wing shaped cutout comprises a reflective material.

20. The AMD as in claim 16 wherein the wing shaped cutout comprises an iridescent material.
